(19) United States
(12) Patent Application Publication
(10) Pub. No.: US 2026/0322139 A1
(43) Pub. Date: Oct. 15, 2026

(54) STORAGE BATTERY CONTROL DEVICE AND ELECTRICITY STORAGE SYSTEM

(71) Applicant: YAZAKI CORPORATION, Tokyo (JP)

(72) Inventor: Takahiro Syouda, Susono-shi (JP)

(21) Appl. No.: 19/693,269

(22) Filed: May 29, 2026

Related U.S. Application Data
(63) Continuation of application No. PCT/JP2024/041941, filed on Nov. 27, 2024.

(30) Foreign Application Priority Data
Dec. 28, 2023 (JP) 2023-222239

(51) Int. Cl. H02J 7/47; H02J 7/44; H02J 7/45; H02J 7/56

(52) U.S. Cl. CPC H02J 7/47; H02J 7/44; H02J 7/45; H02J 7/56

(57) ABSTRACT

There is provided a storage battery control device. After setting communication IDs to module controllers, a string controller executes arrangement identification processing. The arrangement identification processing includes transmission processing of transmitting a control signal for connecting switches to any one of the module controllers, acquisition processing of acquiring a measured value of a voltage sensor in a state in which the switches are connected, and identification processing of identifying an arrangement of storage battery modules corresponding to the module controllers in a string according to the acquired measured value of the voltage sensor.

### CROSS-REFERENCE TO RELATED APPLICATIONS

The present application is a continuation application of PCT/JP2024/041941 that claims priority to Japanese Patent Application No. 2023-222239 filed on Dec. 28, 2023, the entire content of which is incorporated herein by reference.

### TECHNICAL FIELD

The present disclosure relates to a storage battery control device and an electricity storage system.

### BACKGROUND ART

As an in-vehicle data communication system in which a master device and a plurality of slave devices are connected to the same communication bus, there is known a system in which communication addresses of the slave devices are automatically set when the network is started (for example, see JPH04-326896A). In the in-vehicle data communication system described in JPH04-326896A, when connection request information is transmitted from the slave device to the master device when the network is started, the master device sets the communication address of the slave device to be different from those of other slave devices and notifies the slave device of the communication address.

In an electricity storage system including a string in which a plurality of storage battery modules are connected in series, in order to perform communication between a string control unit (master device) corresponding to the string and a plurality of module control units (slave devices) respectively corresponding to the storage battery modules, a method of setting communication IDs of the plurality of module control units will be examined. Examples of the method include a method in which an operator manually sets the communication ID and a method in which a string control unit, which is a master device, automatically sets the communication ID as described in JPH04-326896A.

In the method of manually setting the communication ID, a switch for setting the communication ID is mounted on the module control unit, and the operator sets the switch for each module control unit. In this method, when a mistake occurs in the setting of the switch performed by the operator, all communication in the electricity storage system may be disabled.

In the method in which the string control unit automatically sets the communication ID, automatic allocation processing is repeated in which the communication IDs are transmitted from the string control unit to the plurality of module control units by broadcast communication and each module control unit sequentially responds. In this method, no association is performed between the module control unit to which the communication ID is allocated and the arrangement (arrangement order) of the storage battery module corresponding to the module control unit in the string.

Therefore, for example, when an abnormality of the storage battery module is notified from the module control unit to the string control unit, the string control unit cannot identify the arrangement of the storage battery module corresponding to the module control unit that performed the abnormality notification in the string.

### SUMMARY OF INVENTION

The present disclosure provides a storage battery control device and an electricity storage system in which, in the electricity storage system including a string in which a plurality of storage battery modules are connected in series, a string control unit can identify the arrangement of the storage battery module in the string after communication IDs of a plurality of module control units are automatically set.

According to an illustrative aspect of the present disclosure, there is provided a storage battery control device for controlling an electricity storage system including a string in which a plurality of storage battery modules are connected in series, the storage battery control device including: a plurality of module control units provided respectively corresponding to the storage battery modules; a string control unit provided corresponding to the string, and configured to set communication IDs for the plurality of module control units and communicate with the plurality of module control units; a signal line connecting a negative electrode side of the storage battery module arranged closest to a negative electrode side of the string among the plurality of storage battery modules to a positive electrode side of each of the plurality of storage battery modules; a voltage sensor provided on the signal line; and a plurality of switches provided respectively corresponding to the storage battery modules, and configured to connect or disconnect the positive electrode side of the storage battery module to or from the signal line in response to a control signal transmitted by the module control unit. The string control unit is configured to, after setting the communication IDs for the module control units, execute arrangement identification processing for identifying an arrangement of the storage battery module corresponding to the module control unit in the string, and the arrangement identification processing includes transmission processing of transmitting a control signal to any one of the plurality of module control units to bring the switch into a connected state, acquisition processing of acquiring a measured value of the voltage sensor when the switch is brought into the connected state, and identification processing of identifying, according to the acquired measured value, the arrangement of the storage battery module corresponding to the module control unit in the string.

According to another illustrative aspect of the present disclosure, there is provided an electricity storage system including: the string in which the plurality of storage battery modules are connected in series; and the storage battery control device as above.

### BRIEF DESCRIPTION OF DRAWINGS

FIG. 1 is a circuit diagram illustrating a configuration of a circuit of an electricity storage system including a storage battery control device according to an embodiment of the present disclosure;

FIG. 2 is a block diagram illustrating a configuration of a control of the electricity storage system illustrated in FIG. 1; and

FIG. 3 is a flowchart illustrating arrangement identification processing executed by the storage battery control device illustrated in FIGS. 1 and 2.

### DESCRIPTION OF EMBODIMENTS

Hereinafter, the present disclosure will be described with reference to a preferred embodiment. The present disclosure is not limited to the embodiment to be described below, and the embodiment can be appropriately modified without departing from the gist of the present disclosure. In the following described embodiment, a part of configurations may be not described or illustrated in the drawings, and regarding details of the omitted techniques, publicly known or well-known techniques are appropriately applied as long as there is no contradiction with contents described below.

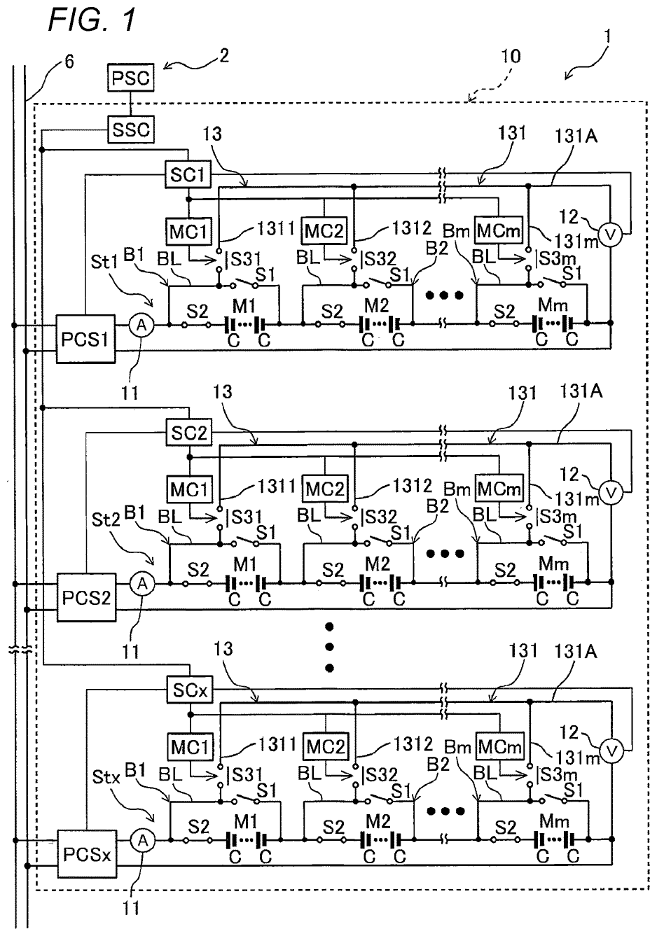

FIG. 1 is a circuit diagram illustrating a configuration of a circuit of an electricity storage system 1 including a storage battery control device 2 according to an embodiment of the present disclosure. The electricity storage system 1 illustrated in this drawing is a stationary power supply and includes a string system 10 and an electricity storage system controller PSC.

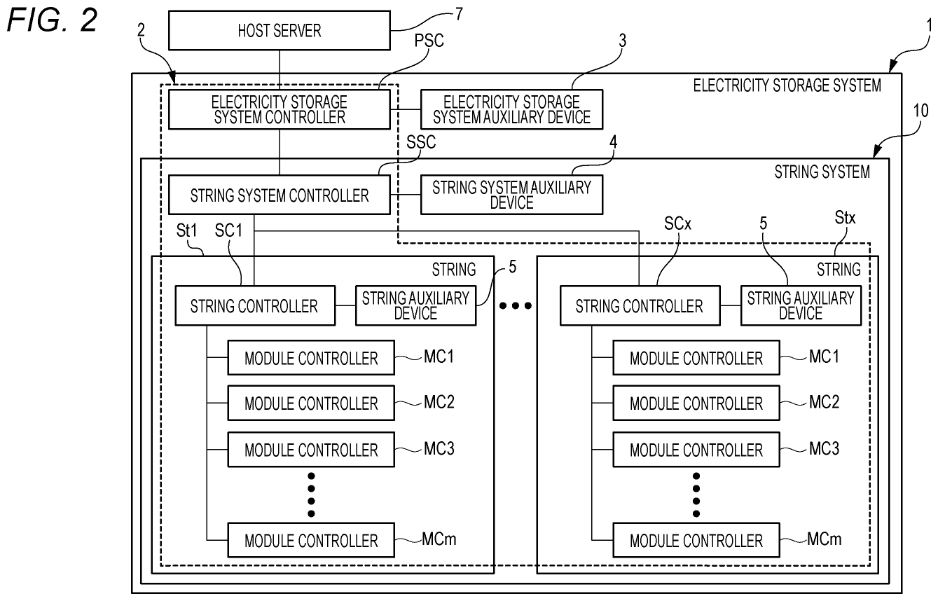

The electricity storage system controller PSC is a control device of the highest hierarchy in the electricity storage system 1, communicates with a host server 7 (see FIG. 2) and a string system controller SSC, and controls an electricity storage system auxiliary device 3 (see FIG. 2). In addition, the electricity storage system controller PSC includes a display input device (not illustrated) such as a touch panel having a display function and an input function.

The string system 10 includes a plurality of strings St1 to Stx, a plurality of power converters PCS1 to PCSx, the string system controller SSC, and a plurality of string controllers SC1 to SCx. The string system controller SSC and the string controllers SC1 to SCx will be described later. When it is not necessary to distinguish and describe the strings St1 to Stx, the strings St1 to Stx are referred to as strings St. In addition, when it is necessary to distinguish and describe the power converters PCS1 to PCSx, the power converters PCS1 to PCSx are referred to as power converters PCS. When it is not necessary to distinguish and describe the string controllers SC1 to SCx, the string controllers SC1 to SCx are referred to as string controllers SC.

The plurality of strings St are connected in parallel to a string bus 6 via the power converters PCS. The string bus 6 is connected to an external system (not illustrated). The string St includes a plurality of storage battery modules M1 to Mm connected in series. The storage battery modules M1 to Mm are provided with module controllers MC1 to MCm, bypass mechanisms B1 to Bm, switches S31 to S3m, and a cell monitoring unit (not illustrated), respectively. When it is not necessary to distinguish and describe the storage battery modules M1 to Mm, the storage battery modules M1 to Mm are referred to as storage battery modules M. When it is not necessary to distinguish and describe the bypass mechanisms B1 to Bm, the bypass mechanisms B1 to Bm are referred to as bypass mechanisms B. When it is not necessary to distinguish and describe the module controllers MC1 to MCm, the module controllers MC1 to MCm are referred to as module controllers MC. When it is not necessary to distinguish and describe the switches S31 to S3m, the switches S31 to S3m are referred to as switches S3.

The storage battery module M includes a plurality of storage battery cells C connected in series. The storage battery cells C are secondary batteries such as lithium ion batteries and lithium ion capacitors, are charged by power supplied from the external system through the power converters PCS, and supply power to the external system by discharging the charged power through the power converters PCS. Although not particularly limited, the storage battery modules M according to the present embodiment are obtained by recycling used storage battery modules, and differ in a degree of deterioration. Instead of the storage battery modules M, a storage battery cell or a storage battery pack may be provided.

The m (an integer of 2 or more) storage battery modules M1 to Mm are arranged from a positive electrode side to a negative electrode side of the string St in ascending order of the reference sign. That is, the storage battery module M1 is disposed closest to the positive electrode side in the string St, the storage battery module M2 is disposed closer to the negative electrode side of the string St than the storage battery module M1, and the storage battery module Mm is disposed closest to the negative electrode side in the string St. The storage battery module M1 closest to the positive electrode side in the string St may be referred to as the storage battery module M1 at a starting end, and the storage battery module Mm closest to the negative electrode side in the string St may be referred to as the storage battery module Mm at a terminal end.

The bypass mechanism B includes a bypass line BL, a switch S1, and a switch S2. The bypass line BL is a power line that bypasses the storage battery module M. The switch S1 is provided on the bypass line BL. The switch S1 is, for example, a mechanical switch, a semiconductor switch, or a relay. The switch S2 is provided between a positive electrode of the storage battery module M and one end of the bypass line BL. The switch S2 is, for example, a mechanical switch, a semiconductor switch, or a relay.

The storage battery module M1 at the starting end and the storage battery module Mm at the terminal end are connected to the external system via the power converter PCS and the string bus 6. When the switch S1 is turned off and the switch S2 is turned on in all the bypass mechanisms B, all the storage battery modules M of the string St are connected to the external system in series. In the bypass mechanism B, a state in which the switch S1 is turned off and the switch S2 is turned on is a state in which the bypass of the storage battery module M is released (hereinafter, referred to as a bypass release state).

Meanwhile, when the switch S2 is turned off and the switch S1 is turned on in any one of the bypass mechanisms B, the storage battery module M corresponding to the bypass mechanism B is bypassed. In the bypass mechanism B, a state in which the switch S1 is turned on and the switch S2 is turned off is a state in which the storage battery module M is bypassed (hereinafter, referred to as a bypass state).

The power converter PCS is a bidirectional converter and is connected to the string bus 6. The power converter PCS is connected to a positive electrode side of the storage battery module M1 at the starting end a negative electrode side of the storage battery module Mm at the terminal end.

When the string St is charged, the power converter PCS converts a voltage received from the string bus 6 and transmits the converted voltage to the plurality of storage battery modules M. Here, a voltage on a string St side changes according to the bypass state (the number of bypassed storage battery modules M) of the plurality of storage battery modules M and a charge state of the plurality of storage battery modules M. Therefore, when the string St is charged, the power converter PCS converts the voltage received from the string bus 6 into the voltage on the string St side and transmits the converted voltage to the plurality of storage battery modules M.

Meanwhile, when the string St is discharged, the power converter PCS converts voltages received from the plurality of storage battery modules M and transmits the converted voltages to the string bus 6. Here, the voltages input to the power converter PCS during discharge change according to the bypass state of the plurality of storage battery modules M and a discharge state of the plurality of storage battery modules M. Accordingly, voltages input to the power converter PCS vary among the string St during discharge. Therefore, when the string St is discharged, the power converter PCS converts the input voltage into a voltage that matches the other strings Sts and transmits the converted voltage to the string bus 6. When the current flowing through the string bus 6 is an alternating current, the power converter PCS includes a synchronization unit for following a change in an instantaneous value.

The cell monitoring unit is connected between the positive and negative electrode terminals of each storage battery cell C, detects an inter-terminal voltage (hereinafter, referred to as a cell voltage) of each storage battery cell C, and transmits a detection signal to the module controller MC. The cell monitoring unit has a cell balancing function and equalizes the cell voltage of the storage battery module M.

The module controller MC has a function of communicating with the string controller SC, a function of controlling the switches S1 and S2 of the bypass mechanism B, and a function of controlling the switch S3. The string controller SC sets communication IDs for the plurality of module controllers MC in order to communicate with the plurality of module controllers MC. The module controller MC controls the switches S1, S2, and S3 according to a control signal transmitted from the string controller SC.

The string St is provided with a current sensor 11, a voltage sensor 12, and an arrangement identification circuit 13. The current sensor 11 is provided between the power converter PCS and the positive electrode side of the storage battery module M1 at the starting end, measures a total current of the string St, and transmits the measured value to the string controller SC. The arrangement of the current sensor 11 is not particularly limited, and may be provided, for example, between the negative electrode side of the storage battery module Mm at the terminal end and the power converter PCS.

The arrangement identification circuit 13 is a circuit for identifying the arrangement of the storage battery module M corresponding to the module controller MC for which the communication ID is set in the string St. The arrangement identification circuit 13 includes the plurality of switches S31 to S3m provided for the respective storage battery modules M, and a signal line 131. The switch S31 is provided corresponding to the storage battery module M1 at the starting end, and is controlled by the module controller MC1. The switch S3m is provided corresponding to the storage battery module Mm at the terminal end, and is controlled by the module controller MCm.

The signal line 131 connects the negative electrode side of the storage battery module Mm at the terminal end and the positive electrode side of each of the plurality of storage battery modules M1 to Mm. The signal line 131 includes a signal line 131A connected to the negative electrode side of the storage battery module Mm at the terminal end, signal lines 1311 to 131m branched from the signal line 131A, and a part of the bypass line BL to which the signal lines 1311 to 131m are connected. “A part” of the bypass line BL is a portion of the bypass line BL that connects the switch S1 to the positive electrode of the storage battery module M.

The voltage sensor 12 is provided on the signal line 131A, and transmits the measured value of the voltage to the string controller SC. The switches S31 to S3m are provided on the respective signal lines 1311 to 131m, and connects or disconnects the positive electrode side of the corresponding storage battery module M to or from the signal line 131 in response to a control signal from the corresponding module controller MC. The switch S3 is, for example, a mechanical switch, a semiconductor switch, or a relay. The switch S3 is preferably a normally open switch, but is not essential.

When any one of the switches S31 to S3m is turned on, the positive electrode side of the storage battery module M corresponding to the switch S3 and the negative electrode side of the storage battery module Mm at the terminal end are connected by the signal line 131. When all the bypass mechanisms B are in the bypass release state in this state, the voltage measured by the voltage sensor 12 is the sum of the voltages of the storage battery modules M located between both ends of the signal line 131.

For example, in a state in which the switch S32 is turned on and the other switches S3 are turned off, the positive electrode side of the storage battery module M2 and the negative electrode side of the storage battery module Mm at the terminal end are connected by the signal line 131. When all the bypass mechanisms B are in the bypass release state in this state, the voltage measured by the voltage sensor 12 is the sum of the voltages of the storage battery modules M2 to Mm. Further, in a state in which the switch S31 is turned on and the other switches S3 are turned off, the positive electrode side of the storage battery module M1 and the negative electrode side of the storage battery module Mm at the terminal end are connected by the signal line 131. When all the bypass mechanisms B are in the bypass release state in this state, the voltage measured by the voltage sensor 12 is the sum of the voltages of the storage battery modules M1 to Mm (total voltage of the string St). Further, in a state in which the switch S3m is turned on and the other switches S3 are turned off, the positive electrode side and the negative electrode side of the storage battery module Mm are connected by the signal line 131. In this state, the voltage measured by the voltage sensor 12 is the voltage of the storage battery module Mm.

FIG. 2 is a block diagram illustrating a configuration of a control of the electricity storage system 1 illustrated in FIG. 1. As illustrated in this drawing, the electricity storage system 1 includes the storage battery control device 2. The storage battery control device 2 includes the electricity storage system controller PSC, the string system controller SSC, the plurality of string controllers SC, and the plurality of module controllers MC.

The electricity storage system controller PSC, the string system controller SSC, the string controller SC, and the module controller MC are provided for each hierarchy. The electricity storage system controller PSC corresponds to a hierarchy of the electricity storage system 1 of the highest order. The string system controller SSC corresponds to a hierarchy of the string system 10 subsequent to the hierarchy of the electricity storage system 1. The string controller SC corresponds to the hierarchy of the string St subsequent to the hierarchy of the string system 10. The module controller MC corresponds to the hierarchy of the storage battery module M subsequent to the hierarchy of the string St.

The electricity storage system controller PSC communicates with the host server 7 and the string system controller SSC, and controls and manages the electricity storage system auxiliary device 3. The host server 7 is provided in a facility of an aggregator, a power receiving facility in a building or a factory, or the like. The host server 7 calculates a charge and discharge power instruction value for the entire electricity storage system 1 (hereinafter, referred to as an electricity storage system charge and discharge power instruction value) according to a state of the electricity storage system 1 and a power demand on a demand side, and transmits the charge and discharge power instruction value to the electricity storage system controller PSC.

Examples of the electricity storage system auxiliary device 3 include a temperature sensor that detects a temperature of an installation environment of the electricity storage system 1 (such as a container), and a fire extinguishing facility (all of which are not illustrated). In a case in which a detected value of the temperature sensor exceeds a threshold value, the electricity storage system controller PSC determines that the temperature of the installation environment of the electricity storage system 1 is abnormal, and transmits an abnormality notification to the display input device. In addition, the electricity storage system controller PSC monitors an operating state of the fire extinguishing system.

The electricity storage system controller PSC receives information on the state of the string St (hereinafter, referred to as string state information) and information on the state of the string system 10 (hereinafter, referred to as string system state information) from the string system controller SSC, and transmits the information to the host server 7 and the display input device.

Examples of the state of the string St include operation states such as charge, discharge, pause, and maintenance, the string current, the total string voltage, a state of charge (SOC) of the string St (hereinafter, referred to as a string SOC), a state of health (SOH) of the string St (hereinafter, referred to as a string SOH), and a limit value of charge and discharge power (or charge and discharge current) of the string St (hereinafter, referred to as a string charge and discharge power limit value).

Examples of the state of the string system 10 include a current of the string bus 6 (hereinafter, referred to as a string bus current), a voltage of the string bus 6 (hereinafter, referred to as a string bus voltage), an SOC of the string system 10 (hereinafter, referred to as a string system SOC), an SOH of the string system 10 (hereinafter, referred to as a string system SOH), and a limit value of charge and discharge power (or charge and discharge current) of the string system 10 (hereinafter, referred to as a string system charge and discharge power limit value).

The electricity storage system controller PSC estimates the state of the electricity storage system 1 based on the string state information and the string system state information received from the string system controller SSC. Examples of the state of the electricity storage system 1 include operation states such as charge, discharge, pause, and maintenance, an SOC of the electricity storage system 1 (hereinafter, referred to as an electricity storage system SOC), and an SOH of the electricity storage system 1 (hereinafter, referred to as an electricity storage system SOH). The electricity storage system controller PSC transmits information on the estimated state of the electricity storage system 1 to the display input device as necessary. In the present embodiment in which the string system 10 is single, the string system SOC is equal to the electricity storage system SOC, and the string system SOH is equal to the electricity storage system SOH.

The electricity storage system controller PSC transmits information required for processing of the host server 7 to the host server 7. Examples of the information required for the processing of the host server 7 include the electricity storage system SOC, the electricity storage system SOH, and the string system charge and discharge power limit value. Here, the host server 7 determines a charge and discharge instruction corresponding to the electricity storage system 1 based on the “information required for the processing of the host server 7” received from the electricity storage system controller PSC, and transmits the charge and discharge instruction to the electricity storage system controller PSC. Examples of the charge and discharge instruction include, in addition to the electricity storage system charge and discharge power instruction value, control amounts in a constant voltage (CV) mode, a constant current (CC) mode, and a constant power (CP) mode, and an operation method such as a self-sustained operation or a system interconnection.

The electricity storage system controller PSC transmits various kinds of instruction information input by an operator or the like through the display input device to the string system controller SSC. Examples of the various kinds of instruction information that can be input through the display input device include information of an instruction to execute a maintenance and stop mode (hereinafter, referred to as a maintenance and stop instruction), an instruction to forcibly execute charge and discharge, and an instruction to forcibly execute state estimation.

Examples of the maintenance and stop instruction include an instruction to forcibly cause the electricity storage system auxiliary device 3, a string system auxiliary device 4, and a string auxiliary device 5 such as the power converter PCS or the switches S1, S2, and S3 to operate. By forcibly causing the electricity storage system auxiliary device 3, the string system auxiliary device 4, and the string auxiliary device 5 to operate, operations of the electricity storage system auxiliary device 3, the string system auxiliary device 4, and the string auxiliary device 5 can be confirmed.

Examples of the instruction to forcibly execute charge and discharge include an instruction to specify a predetermined charge and discharge amount and forcibly cause the electricity storage system 1 to execute charge and discharge. By specifying the predetermined charge and discharge amount and forcibly causing the electricity storage system 1 to execute the charge and discharge, whether the electricity storage system 1 can charge and discharge the specified predetermined charge and discharge amount can be confirmed.

Examples of the instruction to forcibly execute the state estimation include an instruction to specify a predetermined item of state estimation and forcibly cause the electricity storage system 1 to execute the state estimation. By specifying the predetermined item of the state estimation and forcibly causing the electricity storage system 1 to execute the state estimation, for example, the item of the state estimation such as the string system SOH and the electricity storage system SOH can be acquired at any timing.

The string system controller SSC communicates with the electricity storage system controller PSC and the plurality of string controllers SC, and controls and manages the string system auxiliary device 4. Examples of the string system auxiliary device 4 include a temperature sensor that detects an atmospheric temperature, a cooling device in the string system 10, a disconnecting device of the string bus 6, a current sensor that detects a string bus current, and a voltage sensor that detects a string bus voltage (all of which are not illustrated).

The string system controller SSC receives the string state information from the plurality of string controllers SC. Examples of the states of the strings St include operation states such as charge, discharge, pause, and maintenance, the string current, the total string voltage, the string SOC, the string SOH, the string charge and discharge power limit value, and a state of the string system auxiliary device 4. Examples of the state of the string system auxiliary device 4 include the string bus current and the string bus voltage.

The string system controller SSC estimates the state of the string system 10 based on the string state information received from the plurality of string controllers SC. Examples of the state of the string system 10 include the string bus current, the string bus voltage, the string system SOC, the string system SOH, and the string system charge and discharge power limit value. The state of the string system 10 may be estimated by the electricity storage system controller PSC.

For example, in a case in which detected values of the temperature sensor, the current sensor, and the voltage sensor or an estimated value of the state of the string system 10 are out of a range of a threshold value, the string system controller SSC determines that the string system 10 is abnormal, stops the operation of the string system 10, or transmits an abnormality notification to the electricity storage system controller PSC.

The string system controller SSC transmits, to the electricity storage system controller PSC, information required for the processing of the electricity storage system controller PSC among information received from the plurality of string controllers SC and information estimated by the string system controller SSC. Examples of the information required for the processing of the electricity storage system controller PSC include the string system SOC, the string system SOH, and the string system charge and discharge power limit value.

The electricity storage system controller PSC determines an instruction corresponding to the string system 10 based on the “information required for the processing of the electricity storage system controller PSC” received from the string system controller SSC, and transmits the instruction information to the string system controller SSC. Examples of the instruction include a charge and discharge instruction for the string system 10 in a charge and discharge mode, an instruction to individually control each unit of the string system 10 (hereinafter, referred to as an individual control instruction) in a maintenance mode, and a state estimation instruction for the string system 10 in a state estimation mode. Examples of the charge and discharge instruction for the string system 10 in the charge and discharge mode include, in addition to the charge and discharge power instruction value assigned to each string system 10, the control amounts in the constant voltage (CV) mode, the constant current (CC) mode, and the constant power (CP) mode, and the operation method such as a self-sustained operation or a system interconnection. Examples of the individual control instruction for the string system 10 in the maintenance mode include an instruction to individually control the power converter PCS, the switches S1 and S2 of the bypass mechanism B, and the string system auxiliary device 4. Examples of the state estimation instruction for the string system 10 in the state estimation mode include an execution instruction of a predetermined control required for executing the state estimation of the string St.

The string system controller SSC receives the above-described instruction corresponding to the string system 10 from the electricity storage system controller PSC, and determines whether the operation state of the string system 10 needs to be updated by comparing the currently received instruction with the previously received instruction. In a case in which it is determined that the operation state of the string system 10 needs to be updated, the string system controller SSC determines an operation mode of the string St, permission for a bypass request from the string controller SC, and the string charge and discharge power instruction value assigned to the string St. Examples of the operation mode of the string St include the charge and discharge mode, the state estimation mode, and the maintenance and stop mode.

The string controller SC communicates with the string system controller SSC and the plurality of module controllers MC, and controls and manages the string auxiliary device 5. Examples of the string auxiliary device 5 include the power converter PCS, the current sensor 11 (see FIG. 1) that detects the string current, the voltage sensor (not illustrated) that detects the total string voltage, and the switches S1, S2, and S3.

The string controller SC receives information on the state of the storage battery module M (hereinafter, referred to as module state information) from the module controller MC. Examples of the state of the storage battery module M include the temperature, current, voltage, and cell voltage of the storage battery module M, and the state of the bypass mechanism B.

The string controller SC estimates an SOC, an SOH, a charge and discharge power limit value, and the like of the storage battery module M based on the module state information received from the module controller MC. The estimation of the SOC, the SOH, the charge and discharge power limit value, and the like of the storage battery module M may be executed by the module controller MC. In this case, the module controller MC may transmit an estimation result thereof to the string controller SC.

The string controller SC estimates the state of the string St based on the module state information received from the module controller MC. Examples of the state of the string St include the string SOH, the string SOC, and the string charge and discharge power limit value. The estimation of the state of the string ST may be executed by the string system controller SSC. In this case, the string controller SC may transmit the module state information and an estimation result of the state of the storage battery to the string system controller SSC.

When the cell voltage, the total string current, the estimated value of the state of the string St, or the like is out of the threshold value range, the string controller SC determines that the string St is abnormal. In this case, the string controller SC stops the operation of the string St, or transmits an abnormality notification to the string system controller SSC.

The string controller SC transmits, to the string system controller SSC, information required for the processing of the string system controller SSC among the information received from the module controller MC and the information estimated by the string controller SC. Examples of the information required for the processing of the string system controller SSC include the temperature, the current, the voltage, the SOC, the SOH, the charge and discharge power limit value, and the cell voltage of the storage battery module M, the state of the bypass mechanism B, the string SOC, the string SOH, and the string charge and discharge power limit value.

The string system controller SSC determines an instruction corresponding to each string St based on the “information required for the processing of the string system controller SSC” received from the string controller SC, and transmits the instruction information to the string controller SC. Examples of the instruction include a charge and discharge instruction for the string St in the charge and discharge mode, an individual control instruction for the string St in the maintenance mode, and a state estimation instruction for the string St in the state estimation mode. Examples of an item of the charge and discharge instruction for the string St in the charge and discharge mode include, in addition to the string charge and discharge power instruction value, the control amounts in the constant voltage mode, the constant current mode, and the constant power mode, and the operation method such as a self-sustained operation or a system interconnection. Examples of an item of the individual control instruction for the string St in the maintenance mode include an instruction to individually control the bypass mechanism B. Examples of an item of the state estimation instruction in the state estimation mode include executing charge and discharge at a constant current and recording the voltage of the storage battery module M at that time.

The string controller SC receives the above-described instruction information corresponding to each string St from the string system controller SSC, and determines whether a bypass schedule of the string St needs to be updated by comparing the currently received instruction information with the previously received instruction information. The bypass schedule of the string St is a plan related to the bypass of the storage battery module M executed by the bypass mechanism B, and is determined based on a predetermined criterion. The string controller SC determines whether switching of charge to discharge or discharge to charge is executed in the string St, and determines that the bypass schedule needs to be updated in a case in which the switching is executed. In a case in which the bypass schedule needs to be updated, the string controller SC determines the bypass schedule of the storage battery module M based on the storage battery state information received from the module controller MC and an estimation result of the state of the storage battery module M.

Meanwhile, the string controller SC determines whether string charge and discharge power needs to be controlled by comparing the current and previous module state information received from the module controller MC and the current and previous estimation results of the state of the storage batteries. In a case in which the string charge and discharge power needs to be controlled, the string controller SC transmits a control signal corresponding to the string charge and discharge power instruction value received from the string system controller SSC to a control device (not illustrated) of the power converter PCS.

In a case in which the maintenance and stop instruction is received from the string system controller SSC, the string controller SC analyzes the received maintenance and stop instruction and determines a type of maintenance to be executed. Examples of the type of the maintenance include an individual control, self-diagnosis, and replacement of the storage battery (hereinafter, referred to as storage battery replacement).

Examples of the individual control include a control for individually turning on and off a cooling device (not illustrated) in the string St. Examples of the self-diagnosis include executing abnormality determination for determining an abnormality that determination is difficult to be executed during operation in the state estimation mode or the charge and discharge mode. Examples of the abnormality determination include performing a special control on the power converter PCS and the like, the switches S1 and S2 of the bypass mechanism B, and the like, acquiring responses thereof by various sensors, and determining the presence or absence of an abnormality. Examples of the storage battery replacement include guiding the storage battery replacement for the storage battery module M in which progress of deterioration, failure, or the like occurs. When the storage battery replacement is executed, a work guide is displayed on the display input device of the electricity storage system controller PSC, and a necessary control such as stopping the string St to be subjected to the storage battery replacement is executed in the electricity storage system 1.

In a case in which the state estimation instruction is received from the string system controller SSC, the string controller SC compares the currently received string charge and discharge power instruction value with the previously received string charge and discharge power instruction value, and determines whether there is a change. When there is a change in the previous and current string charge and discharge power instruction values, the string controller SC controls the power converter PCS or the switches S1 and S2 of the bypass mechanism B by a predetermined method so that the state of the string St can be estimated. Examples of the control method of the power converter PCS or the like when the state estimation mode is executed include a method of performing a constant current control on the power converter PCS. In addition, examples of the control method of the switches S1 and S2 of the bypass mechanism B when the state estimation mode is executed include a method of sequentially bypassing the storage battery modules M which are fully discharged at the time of discharge.

The string controller SC records the module state information received from the module controller MC. In addition, the string controller SC updates parameters used when the state estimation is executed as necessary based on the module state information received from the module controller MC. Examples of the parameters include the SOH of the storage battery module M, a map of a charge and discharge limit value of the storage battery module M, and an SOC-open circuit voltage (OCV) characteristic.

The module controller MC communicates with the string controller SC and the cell monitoring unit. The module controller MC controls the switches S1 and S2 of the bypass mechanism B, the cell monitoring unit, the switch S3, and the like. The module controller MC receives the module state information from the cell monitoring unit or the like. Examples of the module state information include the total voltage of the storage battery module M, the temperature of the storage battery module M, and the cell voltage. The cell monitoring unit receives detection signals from various sensors (not illustrated) such as a module voltage sensor that detects a voltage of the storage battery module M, a cell voltage sensor that detects a cell voltage, and a module temperature sensor that detects a temperature of the storage battery module M. The cell monitoring unit may be configured as a single unit, or may be configured using a battery cell monitoring integrated circuit (IC) in the module controller MC.

The module controller MC receives the module state information from the cell monitoring unit, and estimates the state of the storage battery module M based on the received information. Examples of the state of the storage battery module M to be estimated include the SOC, the SOH, and the charge and discharge power limit value of the storage battery module M. The state of the storage battery module M may be estimated by the string controller SC.

For example, when the detected values of the module voltage sensor, the cell voltage sensor, and the module temperature sensor or the estimated value of the state of the storage battery module M are out of the threshold value range, the module controller MC determines that the storage battery module M is abnormal. Then, the module controller MC disconnects the switch S2 of the bypass mechanism B of the storage battery module M which is determined to be abnormal, or transmits an abnormality notification to the string controller SC.

The module controller MC transmits, to the string controller SC, information required for processing of a host controller such as the string controller SC among information received from the cell monitoring unit and information estimated by the module controller MC. Examples of the information required for the processing of the string controller SC include the temperature, the current, the voltage, the SOC, the SOH, the charge and discharge power limit value, and the cell voltage of the storage battery module M, and the states of the switches S1 and S2 of the bypass mechanism B.

The string controller SC determines an instruction for each module controller MC based on the “information required for the processing of the string controller SC” received from the module controller MC and transmits the instruction information. Examples of the instruction include a bypass control of the storage battery module M executed by the switches S1 and S2 of the bypass mechanism B, and a disconnection control of the storage battery module M executed by the switch S2 of the bypass mechanism B.

When there is a change in the previous and current instruction information received from the string controller SC, the module controller MC controls the switches S1 and S2 of the bypass mechanism B to execute the bypass control or the disconnection control described above. In addition, when there is a change in the information received from the cell monitoring unit and the information estimated by the module controller MC, the module controller MC executes an exception control which does not depend on the instruction from the host controller as necessary. Further, the module controller MC transmits an instruction to execute cell balancing on the storage battery module M to the cell monitoring unit.

As described above, in order to perform communication between the string controller SC and the plurality of module controllers MC, it is necessary to set a communication ID for each module controller MC. Therefore, in the electricity storage system 1, communication ID setting processing of setting a communication ID for each module controller MC is executed at the time of initial startup, restart, or the like.

In the communication ID setting processing at the time of the initial startup or the like of the electricity storage system 1, the string controller SC executes automatic communication ID allocation processing of transmitting communication IDs to all the module controllers MC by broadcast communication. With respect to this, each module controller MC responds to the automatic communication ID allocation processing executed by the string controller SC according to a predetermined priority. For example, each module controller MC responds to the automatic communication ID allocation processing executed by the string controller SC after a wait time corresponding to a random number generated in a micro control unit (MCU). Alternatively, collision processing is performed on the responses from the plurality of module controllers MC at the same timing, and as a result, each module controller MC responds to the automatic communication ID allocation processing executed by the string controller SC. That is, the communication ID is set to all the module controllers MC by repeating the processing of giving the communication ID to the module controller MC that could respond to the automatic communication ID allocation processing executed by the string controller SC. The module controller MC for which the communication ID is set does not respond to the automatic communication ID allocation processing executed by the string controller SC.

Here, the automatic communication ID allocation processing executed by the string controller SC and the response of the module controller MC to the processing are performed regardless of the arrangement (arrangement order) of the storage battery modules M in the string St. Therefore, it is necessary to execute processing (hereinafter, referred to as arrangement identification processing) of identifying the arrangement of the storage battery module M corresponding to the module controller MC for which the communication ID is set in the string St. When the arrangement identification processing is not executed, the string controller SC cannot identify the arrangement of the storage battery module M corresponding to the module controller MC for which the communication ID is set in the string St, and the module controller MC itself cannot identify the arrangement of the storage battery module M corresponding to the communication ID set in the storage battery module M itself in the string St. In this case, when an abnormality occurs in the storage battery module M, even if an abnormality notification is transmitted from the module controller MC corresponding to the storage battery module M to the string controller SC, the string controller SC cannot identify the arrangement of the storage battery module M in which the abnormality occurs in the string St.

Therefore, the storage battery control device 2 according to the present embodiment executes not only the communication ID setting processing of setting the communication ID in the module controller MC but also the arrangement identification processing at the time of initial startup or restart of the electricity storage system 1.

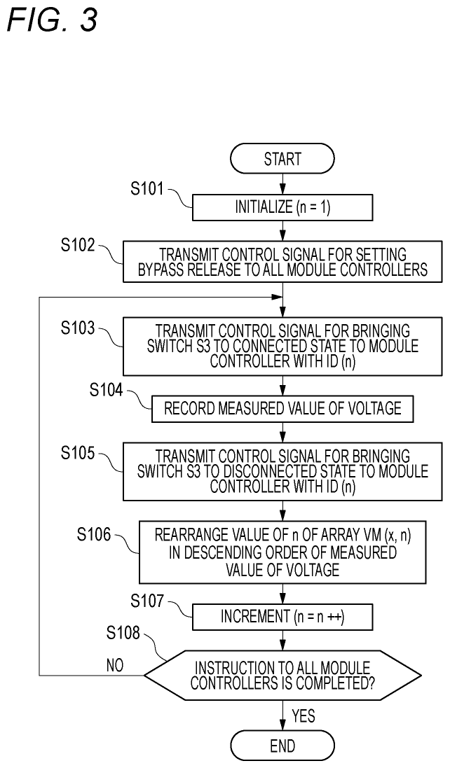

FIG. 3 is a flowchart illustrating the arrangement identification processing executed by the storage battery control device 2 illustrated in FIGS. 1 and 2. The arrangement identification processing is executed after the communication ID setting processing. In the following description, the communication ID set for each module controller MC is referred to as ID (n). n is a value for identifying the module controller MC, and n=1 to m. m is the number of module controllers MC and storage battery modules M in the string St.

The string controller SC stores in advance an array VM (x, n) having a value (x) for identifying the string St and a value (n) for identifying the module controller MC as elements. In the array VM (x, n) in an initial state, n is arranged in the order of n=1,2, . . . , m.

Here, at a stage before the start of the processing illustrated in the flowchart of FIG. 3, the ID (n) and the storage battery modules M1 to Mm are not associated with each other. Therefore, for example, as described above, ID (1) is set for the module controllers MC2 to MCm corresponding to the storage battery modules M2 to Mm other than the storage battery module M1 at the starting end, and ID (2) is set for the module controllers MC1 and MC3 to MCm corresponding to the storage battery modules M1 and M3 to Mm other than the second storage battery module M2.

First, the string controller SC initializes various management parameters and variables (step S101). In the present embodiment, n=1. Next, the string controller SC transmits a control signal for setting the bypass release state to all the module controllers MC (step S102). In step S102, all the module controllers MC turn off the switches S1 and turn on the switches S2 of the corresponding bypass mechanisms B. Accordingly, all the storage battery modules M in the string St are connected in series.

Thereafter, the processing of steps S103 to S108 are repeated from n=1 to n=m. First, the string controller SC transmits a control signal for bringing the switch S3 to a connected state to the module controller MC for which the ID (n) is set (step S103). Accordingly, the positive electrode of the storage battery module M corresponding to the module controller MC for which the ID (n) is set is connected to the signal line 131.

Next, the string controller SC acquires and records the measured value of the voltage measured by the voltage sensor 12 (step S104). Here, when the switch S31 corresponding to the storage battery module M1 at the starting end is in the connected state, the measured value of the voltage sensor 12 is maximized, and the measured value of the voltage sensor 12 decreases as the switch S3 in the connected state moves to S32, . . . , S3m and the terminal end side of the string St. That is, when the switch S31 is in the connected state, the measured value of the voltage sensor 12 is V1+V2+ . . . +Vm. V1, V2, . . . , Vm are voltages of the storage battery modules M1, M2, . . . , Mm, respectively. When the switch S32 is in the connected state, the measured value of the voltage sensor 12 is V2+ . . . +Vm. When the switch S3m is in the connected state, the measured value of the voltage sensor 12 is Vm.

Next, the string controller SC transmits a control signal for bringing the switch S3 to a disconnected state to the module controller MC for which the ID (n) is set (step S105). Accordingly, the connection between the positive electrode of the storage battery module M corresponding to the module controller MC for which the ID (n) is set and the signal line 131 is disconnected.

Next, the string controller SC rearranges the values of n of the array VM (x, n) in descending order of the measured value of the voltage sensor 12 recorded in step S104 (step S106). Specifically, the string controller SC rearranges the value of n of the array VM (x, n) such that the value of n of ID (n) set for the module controller MC corresponding to the switch S31 is the first, the value of n of ID (n) set for the module controller MC corresponding to the switch S32 is the second, and the value of n of ID (n) set for the module controller MC corresponding to the switch S3m is the last.

Next, the string controller SC increments the value of n (step S107). Next, the string controller SC determines whether the instruction to all the module controllers MC is completed (step S108). Specifically, the string controller SC determines whether the measured value of the voltage measured by the voltage sensor 12 is recorded for all ID (n) from n=1 to n=m. If the determination is no in step S108, the processing of steps S103 to S108 is repeated, and if the determination is yes in step S108, the arrangement identification processing ends.

As described above, in the storage battery control device 2 according to the present embodiment, the negative electrode side of the storage battery module Mm at the terminal end and the positive electrode side of each of the plurality of storage battery modules M1 to Mm are connected by the signal line 131. The signal line 131 is provided with the voltage sensor 12. The switches S31 to S3m are provided corresponding to the storage battery modules M1 to Mm, respectively. The switches S31 to S3m connect or disconnect the positive electrode sides of the corresponding storage battery modules M1 to Mm to or from the signal line 131 in response to control signals transmitted by the corresponding module controllers MC1 to MCm.

Here, after setting the communications ID to the module controllers MC1 to MCm, the string controller SC executes the arrangement identification processing for identifying the arrangement of the storage battery modules M1 to Mm corresponding to the module controllers MC1 to MCm in the string St. The arrangement identification processing includes the following transmission processing, acquisition processing, and identification processing, and is performed on all the module controllers MC1 to MCm.

In the transmission processing, the string controller SC transmits a control signal for connecting the switch S3 to any one of the plurality of module controllers MC1 to MCm. Next, in the acquisition processing, the string controller SC acquires the measured value of the voltage sensor 12 in a state in which the switch S3 is connected. Next, in the identification processing, the string controller SC identifies the arrangement of the storage battery modules M1 to Mm corresponding to the module controllers MC1 to MCm in the string St according to the acquired measured value of the voltage sensor 12.

As described above, according to the storage battery control device 2 according to the present embodiment, it is possible to identify the physical arrangement (arrangement order) of the storage battery modules M1 to Mm corresponding to the module controllers MC1 to MCm for which the communication ID is automatically set in the string St. Therefore, for example, when the abnormality notification is sent from the module controllers MC1 to MCm to the string controller SC, the string controller SC can identify the physical arrangement of the abnormal storage battery modules M1 to Mm in the string St.

In the storage battery control device 2 according to the present embodiment, the string controller SC stores the array VM having the communication ID as an element, and rearranges the communication ID of the array VM according to the acquired measured value of the voltage sensor 12 in the identification processing. Accordingly, the string controller SC can identify the arrangement of the storage battery module M corresponding to the module controller MC for which the communication ID is set in the string St with reference to the array VM in which the communication IDs are rearranged.

In the electricity storage system 1 according to the present embodiment, the bypass mechanisms B1 to Bm are provided corresponding to the storage battery modules M1 to Mm, respectively. The bypass mechanisms B1 to Bm bring the corresponding storage battery modules M1 to Mm to the bypass state or the bypass release state according to the control signals transmitted by the corresponding module controllers MC1 to MCm. With respect to this, the string controller SC transmits a control signal for bringing all the storage battery modules M1 to Mm to the bypass release state to all the module controllers MC1 to MCm before executing the arrangement identification processing. Accordingly, it is possible to execute the arrangement identification processing in a state in which all the storage battery modules M1 to Mm are connected in series, and it is possible to acquire different measured values of the voltage sensor 12 according to the connected switches S31 to S3m.

Although the present disclosure has been described above based on the above embodiment, the present disclosure is not limited to the above embodiment. Modifications may be made without departing from the gist of the present disclosure, or publicly known or well-known techniques may be appropriately combined.

For example, in the embodiment described above, the value of n of ID (n), which is an element of the array, is rearranged in descending order of the measured value of the voltage sensor 12 acquired in the arrangement identification processing, but this is not essential. As a result of executing the arrangement identification processing, information that can specify the correspondence relation between the ID (n) and the arrangement of the storage battery modules M1 to Mm in the string St according to the measured value of the voltage sensor 12 may be recorded.

In the embodiment described above, the signal lines 1311 to 131m are connected to the power line of the string St via the bypass lines BL, but this is not essential. The signal lines 1311 to 131m may be directly connected to the power line of the string St.

In the embodiment described above, the string controller SC corresponding to the hierarchy of the string St is set as a master device, and the plurality of module controllers MC corresponding to the hierarchy of the storage battery module M are set as slave devices, but this is not essential. Any one of the plurality of module controllers MC may be set as a master device, the other module controllers MC may be set as slave devices, and a master controller may set a communication ID or transmit a control signal to a slave controller.

Here, features of embodiments of the storage battery control device and the electricity storage system according to the present disclosure described above will be briefly summarized and listed in the following aspects 1 to 4.

According to the aspect 1 of the present disclosure, there is provided a storage battery control device (2) for controlling an electricity storage system (1) including a string (St, St1 to Stx) in which a plurality of storage battery modules (M, M1 to Mm) are connected in series.

The storage battery control device includes:
a plurality of module control units (MC, MC1 to MCm) provided respectively corresponding to the storage battery modules (M, M1 to Mm);
a string control unit (SC, SC1 to SCx) provided corresponding to the string (St, St1 to Stx), and configured to set communication IDs for the plurality of module control units (MC, MC1 to MCm) and communicate with the plurality of module control units (MC, MC1 to MCm);
a signal line (131) connecting a negative electrode side of the storage battery module (M, M1 to Mm) arranged closest to a negative electrode side of the string (St, St1 to Stx) among the plurality of storage battery modules (M, M1 to Mm) to a positive electrode side of each of the plurality of storage battery modules (M, M1 to Mm);
a voltage sensor (12) provided on the signal line (131); and
a plurality of switches (S3, S31 to S3m) provided respectively corresponding to the storage battery modules (M, M1 to Mm), and configured to connect or disconnect the positive electrode side of the storage battery module (M, M1 to Mm) to or from the signal line (131) in response to a control signal transmitted by the module control unit (MC, MC1 to MCm), in which
the string control unit (SC, SC1 to SCx) is configured to, after setting the communication IDs for the module control units (MC, MC1 to MCm), execute arrangement identification processing for identifying an arrangement of the storage battery module (M, M1 to Mm) corresponding to the module control unit (MC, MC1 to MCm) in the string (St, St1 to Stx), and
the arrangement identification processing includes
   transmission processing of transmitting a control signal to any one of the plurality of module control units (MC, MC1 to MCm) to bring the switch (S3, S31 to S3m) into a connected state,
   acquisition processing of acquiring a measured value of the voltage sensor (12) when the switch (S3, S31 to S3m) is brought into the connected state, and
identification processing of identifying, according to the acquired measured value, the arrangement of the storage battery module (M, M1 to Mm) corresponding to the module control unit (MC, MC1 to MCm) in the string (St, St1 to Stx).

According to the aspect 2 of the present disclosure, in the storage battery control device (2) according to the aspect 1,
the string control unit (SC, SC1 to SCx) is configured to store an array having the communication ID as an element, and
the identification processing includes processing of rearranging the communication ID of the array according to the acquired measured value.

According to the aspect 3 of the present disclosure, in the storage battery control device (2) according to the aspect 1,
the electricity storage system (1) includes a plurality of bypass units (B, B1 to Bm) provided respectively corresponding to the storage battery modules (M, M1 to Mm) and configured to bring the storage battery module (M, M1 to Mm) to a bypass state or a bypass release state according to a control signal transmitted by the module control unit (MC, MC1 to MCm), and
the string control unit (SC, SC1 to SCx) is configured to transmit a control signal for bringing all the storage battery modules (M, M1 to Mm) to the bypass release state to the plurality of module control units (MC, MC1 to MCm) before executing the arrangement identification processing.

According to the aspect 4 of the present disclosure, there is provided an electricity storage system (1) including:
a string (St, St1 to Stx) in which a plurality of storage battery modules (M, M1 to Mm) are connected in series; and
the storage battery control device (2) according to any one of the aspects 1 to 3.

According to the present disclosure, in the electricity storage system including the string in which the plurality of storage battery modules are connected in series, the string control unit can identify the arrangement of the storage battery modules in the string after the communication IDs of the plurality of module control units are automatically set.

Although the present disclosure is described in detail and with reference to the specific embodiments, it is apparent to those skilled in the art that various changes and modifications can be made without departing from the spirit and scope of the present disclosure.

The present application is based on a Japanese patent application (Japanese Patent Application No. 2023-222239) filed on Dec. 28, 2023, and the contents thereof are incorporated herein by reference.

What is claimed is:

1. A storage battery control device for controlling an electricity storage system including a string in which a plurality of storage battery modules are connected in series, the storage battery control device comprising:
a plurality of module control units provided respectively corresponding to the storage battery modules;
a string control unit provided corresponding to the string, and configured to set communication IDs for the plurality of module control units and communicate with the plurality of module control units;
a signal line connecting a negative electrode side of the storage battery module arranged closest to a negative electrode side of the string among the plurality of storage battery modules to a positive electrode side of each of the plurality of storage battery modules;
a voltage sensor provided on the signal line; and
a plurality of switches provided respectively corresponding to the storage battery modules, and configured to connect or disconnect the positive electrode side of the storage battery module to or from the signal line in response to a control signal transmitted by the module control unit, wherein
the string control unit is configured to, after setting the communication IDs for the module control units, execute arrangement identification processing for identifying an arrangement of the storage battery module corresponding to the module control unit in the string, and
the arrangement identification processing includes:
transmission processing of transmitting a control signal to any one of the plurality of module control units to bring the switch into a connected state;
acquisition processing of acquiring a measured value of the voltage sensor when the switch is brought into the connected state; and
identification processing of identifying, according to the acquired measured value, the arrangement of the storage battery module corresponding to the module control unit in the string.

2. The storage battery control device according to claim 1, wherein
the string control unit is configured to store an array having the communication ID as an element, and
the identification processing includes processing of rearranging the communication ID of the array according to the acquired measured value.

3. The storage battery control device according to claim 1, wherein
the electricity storage system includes a plurality of bypass units provided respectively corresponding to the storage battery modules and configured to bring the storage battery module to a bypass state or a bypass release state according to a control signal transmitted by the module control unit, and
the string control unit is configured to transmit a control signal for bringing all the storage battery modules to the bypass release state to the plurality of module control units before executing the arrangement identification processing.

4. An electricity storage system comprising:
the string in which the plurality of storage battery modules are connected in series; and
the storage battery control device according to claim 1.
